(19) United States
(12) Patent Application Publication
(10) Pub. No.: US 2013/0251164 A1
(43) Pub. Date: Sep. 26, 2013

(54) LOUDSPEAKER DRIVE CIRCUIT FOR DETERMINING LOUDSPEAKER CHARACTERISTICS AND/OR DIAGNOSTICS

(71) Applicant: NXP B.V., Eindhoven (NL)

(72) Inventor: Temujin GAUTAMA, Boutersem (BE)

(73) Assignee: NXP B.V., Eindhoven (NL)

(21) Appl. No.: 13/762,811

(22) Filed: Feb. 8, 2013

(30) Foreign Application Priority Data
Mar. 20, 2012 (EP) 12160401.1

(51) Int. Cl. H04R 29/00

(52) U.S. Cl. CPC H04R 29/001
USPC 381/59

(57) ABSTRACT

A loudspeaker amplifier drive circuit performs analysis of various signals relating to the input and output of the amplifier such that the characteristics and/or diagnostics of a loudspeaker driven by the amplifier can be derived. These are then presented as outputs, so that different circuitry can make use of the information for audio signal processing.

This invention relates to a device for determining loudspeaker characteristics and/or diagnostics.

It is well known that the output of a loudspeaker should be controlled in such a way that it is not simply driven by any input signal. For example, signals should be controlled to prevent loudspeaker failure. Two important causes of loudspeaker failure are mechanical and thermal defects.

A mechanical defect arises when the loudspeaker diaphragm is displaced beyond a certain limit, which is usually supplied by the manufacturer.

A thermal defect occurs when there is too much heat dissipation in the loudspeaker. Going beyond the displacement and/or thermal limit either damages the loudspeaker immediately, or can considerably reduce its expected life-time.

There exist several methods to limit the displacement of the diaphragm of a loudspeaker to prevent such failures, for example by processing the input signal with variable cut-off filters (high-pass or other), the characteristics of which are controlled via a feedforward or feedback control loop. The measured control signal is referred to as the displacement predictor, and this requires modelling of the loudspeaker characteristics so that the displacement can be predicted in response to a given input signal.

Many applications of electrodynamic loudspeaker modelling, such as loudspeaker protection as mentioned above and also linearisation of the loudspeaker output, contain a module that predicts the diaphragm displacement, also referred to as cone excursion, using a model of a loudspeaker. This model can be linear or non-linear and usually has parameters that allow for a physical interpretation.

Loudspeaker characteristics are thus used to implement loudspeaker protection mechanisms, to prevent loudspeaker failure. These characteristics can be provided by the manufacturer, following detailed testing. However, they may vary from one device to another. For this reason, each individual loudspeaker is ideally characterised.

According to the invention, there is provided an apparatus and method as defined in the independent claims.

In one aspect, the invention provides a loudspeaker drive circuit for deriving characteristics and/or diagnostics of a loudspeaker driven by the drive circuit, comprising:

an amplifier;

means for determining a clipping level of the amplifier;

means for sensing the current flowing into the loudspeaker; and

a processing module to determine the loudspeaker characteristics and/or diagnostics, based on the input audio signal, the sensed current and the clipping level of the amplifier; and

means for outputting loudspeaker characteristics and/or diagnostics.

The device of the invention essentially uses an audio amplifier (with known gain) and a means to measure the current flowing into the loudspeaker load driven by the amplifier, in combination with determination of the clipping level of the amplifier. The known gain and the clipping level together define the amplifier transfer function. The amplifier clipping can vary for example with the battery level.

A number of loudspeaker diagnostics can be computed and output, such that they can conveniently be used for further processing, for example to implement a loudspeaker protection mechanism. The loudspeaker diagnostics can be mechanical characteristics (for example Fres, Qres) and predicted or measured signals that quantify the behaviour of the loudspeaker.

The device thus combines an audio amplifier and a processing module to determine a number of loudspeaker diagnostics, which are provided as outputs. This device allows a user to develop audio processing and loudspeaker protection software modules without the need to spend development effort into the characterisation of the loudspeaker.

In this way, the diagnostic and characterisation of the loudspeaker is built in to the amplification function, but the further signal processing for overload or thermal protection (for example) remain separate. This means that the amplifier stage can be used by a variety of signal processing platforms, giving flexibility to the end user in how to implement the desired signal processing.

The drive circuit preferably comprises a delay element between the audio input and the amplifier, such that the derived amplifier output voltage is a predicted amplifier output voltage to be supplied to the loudspeaker after the delay of the delay element. This enables the protection which will use the characteristics/diagnostics to be implemented in a predictive (feedforward) manner.

The processing module can be adapted to derive the amplifier output voltage which is supplied to the loudspeaker based on the audio input provided to the circuit and the known gain and clipping level of the amplifier. This gives the predicted output when a delay element is used.

The processing module can derive a loudspeaker temperature, for example from the sensed current and the amplifier output voltage supplied to the loudspeaker.

The processing module can also be adapted to derive an electrical impedance function from the amplifier output voltage and the sensed current. This can be used to obtain various loudspeaker parameters, including a voltage to displacement transfer function for the loudspeaker, from which the loudspeaker excursion can be obtained based on the amplifier output voltage. A measure of loudspeaker distortion can also be obtained based on the electrical impedance function. A resonance frequency for the loudspeaker and a Q-factor can also be obtained for the loudspeaker from the electrical impedance function.

The loudspeaker amplifier can be used as the drive circuit for using the loudspeaker.

In another aspect, the invention provides a method of deriving characteristics and/or diagnostics of a loudspeaker, comprising:

driving the loudspeaker using an amplifier;

determining a clipping level of the amplifier;

sensing the current flowing into the loudspeaker;

determining the loudspeaker characteristics and/or diagnostics, based on the input audio signal, the sensed current and the clipping level of the amplifier; and

outputting the loudspeaker characteristics and/or diagnostics.

An example of the invention will now be described in detail with reference to the accompanying drawings, in which:

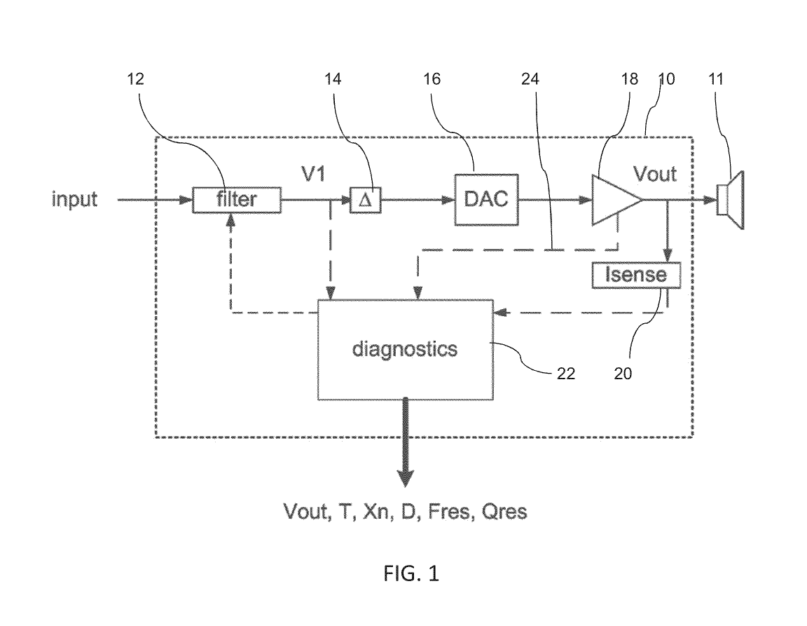

FIG. 1 shows a loudspeaker drive circuit of the invention;

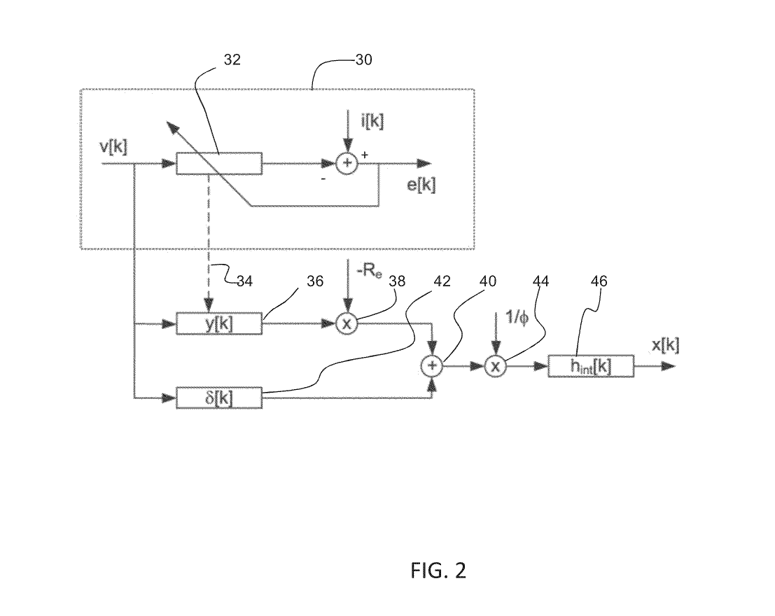

FIG. 2 shows one way of deriving a loudspeaker model.

The invention provides a loudspeaker amplifier, wherein various signals relating to the input and output of the amplifier are analysed such that the characteristics and/or diagnostics of a loudspeaker driven by the amplifier can be derived. These are then presented as outputs, so that different circuitry can make use of the information for audio signal processing.

In this way, information is provided regarding the loudspeaker behaviour that is relevant for audio processing modules, thereby taking away the need for spending significant research effort in the characterisation of the loudspeaker model. Indeed, once the loudspeaker diagnostics, such as those provided by the device of the invention, are available, traditional signal processing modules and control mechanisms can be implemented (dynamic range compression, PID controllers, etc.), without knowledge about how the diagnostics have been obtained.

The invention enables a loudspeaker model to be formed which is specific to an individual loudspeaker, thereby enabling the prediction of the diaphragm displacement, and enables the voice coil temperature to be determined, for thermal protection.

A loudspeaker model is typically based on the physical behaviour of the loudspeaker and the enclosure in which it is mounted. The parameters of a model are determined in order to characterise a specific loudspeaker.

The model parameters can be estimated by minimising the discrepancy between the measured electrical impedance and the impedance predicted by the loudspeaker model (as a function of the parameters). There exist alternatives, such as that described in EP10152597 and EP11170997 (discussed below and not published at the priority date of this application).

To measure the electrical impedance, the voltage across the loudspeaker coil and the current flowing into the loudspeaker need to be known. From this loudspeaker model, useful transfer functions can be derived, such as the voltage-to-displacement transfer function, which predicts the diaphragm displacement for a given input voltage signal. The diaphragm displacement, or cone excursion, is a measure for how far the cone has moved from its rest position. To obtain the correct voltage-to-displacement transfer function, however, an additional parameter needs to be known, namely the so-called force factor or BI-product.

In a linear model, the displacement scales inversely linearly with the force factor, and therefore, the excursion can be linearly predicted up to an (unknown) scaling factor without knowledge of the physical BI-product value. The electrical impedance can also be used to determine the resonance frequency of the loudspeaker and its Q-factor. This information can for example be used to generate a digital filter to linearise the acoustical output of the loudspeaker.

Voice coil temperature estimation is also carried out as part of the characterisation of the loudspeaker.

Loudspeakers are essentially devices to convert electrical energy into acoustical energy. However, much of the electrical power that is applied to the loudspeaker results in heat dissipation, which increases the temperature of the loudspeaker voice coil. There exist methods for predicting the voice coil temperature based on a number of pre-estimated parameters starting from the electrical signal that is sent to the loudspeaker (Chapman, P., May 1998. Thermal simulation of loudspeakers. In: Proceedings of the 104th AES Convention, Amsterdam. Paper number 4667 and Klippel, W., 2004. Nonlinear modelling of the heat transfer in loudspeakers. J. Audio Eng. Soc. 52, 3-25). These methods predict the voice coil temperature based on a thermal model of the loudspeaker, and do not measure the temperature or derivatives thereof.

Other methods derive the temperature from the DC-resistance of the loudspeaker: as the input power is dissipated into heat, the rise in temperature also increases the DC resistance of the voice coil, Re. The temperature of the voice coil, T, can be estimated from the DC resistance, Re, with respect to a reference DC resistance, Re₀, at a reference temperature, T₀ (Behler, G., Sp\ddot{}atling, U., Arimont, T., February 1995. Measuring the loudspeaker's impedance during operation for the evaluation of the voice coil temperature. In: Proceedings of the 98th AES Convention, Paris. Paper number 4001) in the following manner.

$$\frac{{R}_{e}}{{R}_{e 0}} = 1 + {α}_{0} ( T - {T}_{0} ) + {{β}_{0} ( T - {T}_{0} )}^{2} ,$$

α₀ and β₀ are temperature coefficients that depend on the properties of the voice coil material. Thus, if the DC resistance is known for a certain temperature, these values can be used as references for further voice coil temperature estimation, and it is possible to estimate absolute temperatures.

If such values are not known, a temperature increase with respect to a previously measured (but unknown) temperature can be estimated. These methods measure a signal related to the temperature, rather than generating a model-based prediction.

FIG. 1 shows in schematic form the device 10 of the invention which provides an amplified output Vout to a loudspeaker 11.

A digital input signal is filtered by the filter 12 and fed into a delay line 14 and converted to the analog domain by a digital to analogue converter 16 (“DAC”) and amplified by amplifier 18. The current flowing into the loudspeaker is measured (“Isense”) by a current sensor 20, and is used for computing the loudspeaker diagnostics.

The audio input to the circuit can be considered to be the pre-filtered signal or the signal V1 at the output of the filter.

A processing module 22 carries out the calculation of the loudspeaker parameters.

The clipping level of the amplifier is also used for computing the diagnostics, and this is represented by the line 24.

The inputs to the diagnostics module 22 are the following:
Isense: the current flowing into the loudspeaker voice coil;
Vclip: the clipping level of the amplifier 18;
V1 the digital audio signal, of which a delayed version is sent to the DAC 16.

The analog audio signal, Vout, which is sent to the loudspeaker, can be estimated based on V1, the gain and the clipping level of the amplifier 18. Vout can thus be derived by multiplying V1 with the amplifier gain, and passing it through a nonlinear model of the amplifier (such as a hard or a soft clipper).

By estimating (rather than measuring) Vout, a prediction of the analog output voltage is obtained, and the delay line is used for this purpose. The protection can be implemented and can be performed in real time. Thus, the derived signal Vout is a prediction of a future value rather than the current Vout value.

Before and after the nonlinear model, respective up- and down-sampling stages can be added to lower aliasing artifacts (by performing the nonlinear operation at a higher sampling rate, aliasing effects are lowered).

Based on Vout and Isense, the electrical impedance function can be estimated.

The loudspeaker model can then be estimated from the electrical impedance function.

From the electrical impedance model, the voltage-to-displacement transfer function is obtained, and the predicted excursion, Xn, can be computed by applying the transfer function to Vout.

When the BI-product is known, the actual excursion prediction can be computed, if not, it is proportional to the linear prediction (with an unknown scaling factor).

The resonance frequency, Fres, and the Q-factor, Qres, of the loudspeaker can also be obtained from the electrical impedance function, for example based on the position of the frequency where the peak of the impedance function is obtained, and the 3 dB bandwidth.

The voice coil temperature, T, can be estimated from the DC-impedance of the electrical impedance.

From the electrical impedance, a signal, D, that is related to the loudspeaker distortion can also be derived. This signal can for example be obtained as described in EP11173638 (discussed below and not published at the priority date of this application).

The filtering operation (filter 12 in FIG. 1) is optional. It can be included to remove undesired resonance peaks in the acoustical output of the loudspeaker. Indeed, the transfer function of a loudspeaker (from input signal to acoustical output as a function of frequency) can exhibit one or multiple magnitude peaks due to resonance frequencies of the loudspeaker and/or enclosure.

Reducing these resonance peaks can linearise the frequency response and create headroom that may be used for boosting the input signal. The filtering operation may also include a high-pass filter to remove frequencies that are reproduced by the loudspeaker with very low efficiency. The filtering operation may include a boost or ‘correction’ of the lower frequencies to compensate for the high-pass characteristic of the acoustical output of the loudspeaker. Indeed, in a typical loudspeaker, the acoustical output for frequencies below the loudspeaker resonance frequency are lower than for frequencies above resonance.

For example for a closed-box configuration, the acoustical output has a low-frequency roll-off that follows a second-order high-pass filter characteristic for frequencies below resonance. This can be corrected down to a user-defined lower frequency limit (for example as disclosed in Leach, W., 1990. A generalized active equalizer for closed-box loudspeaker systems. J. Audio Eng. Soc. 38, 142-146).

The 14 delay line is also optional. It can be included to implement a look-ahead mechanism. Indeed, it may be necessary to include a look-ahead mechanism in a protection algorithm to ensure that the protection is performed in time.

The invention thus provides a device which contains at least an amplifier, a means for sensing the current flowing from the amplifier, and a module to determine loudspeaker diagnostics. These diagnostics can then be provided as outputs from the device.

The output loudspeaker diagnostics that can be determined include one or several of the following:
the measured or estimated input signal to the loudspeaker;
an estimate of the voice coil temperature;
linear prediction of the loudspeaker diaphragm displacement (possibly scaled by an unknown scaling factor);
a signal related to the loudspeaker nonlinearities;
the resonance frequency and the Q-factor of the loudspeaker.

The amplifier can have a variable gain which is controlled in such a way that the expected power consumption does not exceed a certain threshold.

As mentioned above, EP11170997 (unpublished at the priority date of this application) discloses an alternative way to derive a loudspeaker model. It discloses a time-domain estimation method, where the transfer function between voltage and current (i.e. admittance) are estimated in the time domain and are used to derive a voltage-to-excursion transfer function. This can in turn be used to derive a voltage-to-acoustical-output transfer function. Using a time-domain adaptive filtering approach, the model can be adjusted gradually over time, without abrupt changes. This approach does not require prior knowledge regarding the enclosure (e.g. closed or vented box) and can cope with complex designs of the enclosure.

A non-parametric model is therefore valid in the general case. It is based on a basic property of a loudspeaker/enclosure that is valid for most loudspeaker/enclosure combinations. Therefore, it remains valid when there are defects caused in the production process, or caused by mechanical damage, which would affect the validity of parametric models.

An admittance function (which is inverse to an impedance function, so that either can be derived and they are interchangeable by simply operating a reciprocal function) is obtained over time from the voice coil voltage and current signals. In combination with a delta function, the force factor of the loudspeaker and the blocked electrical impedance, the input-voltage-to-excursion transfer function over time is obtained. This is used to control audio processing for the loudspeaker thereby to implement loudspeaker protection and/or acoustic signal processing.

In order to explain the approach of EP11170997, an analytical form of the voltage-to-excursion transfer function is derived, after which it is shown how it can be estimated in the time domain.

An expression for the voltage-to-excursion transfer function is derived as a function of the admittance, Y(s), which is the inverse of the electrical impedance transfer function, Z(s).

The voltage equation for an electrodynamic loudspeaker, which relates the loudspeaker voice coil voltage, v(t), to the voice coil current, i(t) and the diaphragm velocity \dot{x}(t) is the following:

$$v ( t ) = {R}_{e} i ( t ) + {L}_{e} \frac{d i}{d t} + φ \dot{x} ( t ) , \qquad ( 1 )$$

where Re and Le are the DC resistance and the inductance of the voice coil when the voice coil is mechanically blocked, φ is the force factor or BI-product (assumed to be constant), and \dot{x}(t) is the velocity of the diaphragm.

The Laplace transform yields:

v(s)=Zₑ(s)i(s)+φsx(s), (2)

where Ze(s) is the blocked electrical impedance of the voice coil. The force factor, φ, represents the ratio between the Lorentz force, which is exerted on the cone, and the input current:

φi(s)=f(s). (3)

Estimation of the force factor requires a signal derived from an additional sensor (e.g., a laser to measure the diaphragm displacement), when the loudspeaker is in a known configuration (e.g., infinite baffle, without an enclosure).

Known techniques for estimating or measuring these parameters will be well known to those skilled in the art.

The blocked impedance will not be perfectly constant, for example it changes with temperature. This is not taken into account in the model described below, but the blocked impedance can be re-estimated in the modelling process. There are many methods for estimating the blocked electrical impedance, and its estimation is not part of the proposed invention. For example, reference is made to Leach, W., 2002: “Loudspeaker voice-coil inductance losses: Circuit models, parameter estimation, and effect on frequency response” J. Audio Eng. Soc. 50 (6), 442-450, and Vanderkooy, J., 1989: “A model of loudspeaker driver impedance incorporating eddy currents in the pole structure” J. Audio Eng. Soc. 37, 119-128.

The mechanical impedance is defined as the ratio between force and velocity:

$$\begin{matrix}{Z}_{m} ( s ) = \frac{f ( s )}{sx ( s )} = \frac{φ i ( s )}{sx ( s )} & ( 4 ) \\ ⇔ sx ( s ) = \frac{φ i ( s )}{{Z}_{m} ( s )} & ( 5 )\end{matrix}$$

Rearranging the voltage equation Eq. (2), yields:

$$\begin{matrix}Z ( s ) {=}^{( 5 )} {Z}_{e} ( s ) + \frac{φ }{i ( s )} \frac{φ i ( s )}{{Z}_{m} ( s )} & ( 6 ) \\ = {Z}_{e} ( s ) + \frac{{φ}^{2}}{{Z}_{m} ( s )} , & ( 7 )\end{matrix}$$

from which an expression for the mechanical impedance is derived:

$${Z}_{m} ( s ) = \frac{{φ}^{2}}{Z ( s ) - {Z}_{e} ( s )} \qquad ( 8 )$$

Starting from the voltage equation (Eq. (2)), an expression for the voltage-to-excursion transfer function can be derived:

$$\begin{matrix}\frac{v ( s )}{x ( s )} = {Z}_{e} ( s ) \frac{i ( s )}{x ( s )} + φ s & ( 9 ) \\ {=}^{( 4 )} \frac{{Z}_{e} ( s ) {Z}_{m} ( s ) s}{φ} + φ s , & ( 10 )\end{matrix}$$

from which the Laplace-domain voltage-to-displacement transfer function hᵥₓ(s) is derived:

$${h}_{vx} ( s ) = \frac{x ( s )}{v ( s )} = \frac{\frac{φ}{s}}{{Z}_{e} ( s ) {Z}_{m} ( s ) + {φ}^{2}} \qquad ( 11 )$$

The Laplace domain transfer function can be rewritten:

$$\begin{matrix}{h}_{vx} ( s ) = \frac{\frac{φ}{s}}{{Z}_{e} ( s ) {Z}_{m} ( s ) + {φ}^{2}} & ( 12 ) \\ {=}^{( 8 )} \frac{\frac{φ}{s}}{{Z}_{e} ( s ) \frac{{φ}^{2}}{Z ( s ) - {Z}_{e} ( s )} + {φ}^{2}} & ( 13 ) \\ = \frac{( Z ( s ) - {Z}_{e} ( s ) ) \frac{φ}{s}}{{φ}^{2} Z ( s )} & ( 14 ) \\ = \frac{( Z ( s ) - {Z}_{e} ( s ) ) \frac{1}{s}}{φ Z ( s )} & ( 15 ) \\ = ( 1 - \frac{{Z}_{e} ( s )}{Z ( s )} ) \frac{1}{φ s} & ( 16 )\end{matrix}$$

If it is now assumed that the blocked electrical impedance, Ze(s), is purely resistive (as is often done for micro-speakers), i.e. Ze(s)=Re, the voltage-to-excursion transfer function can be written as:

$${h}_{vx} ( s ) = ( 1 - {R}_{e} Y ( s ) ) \frac{1}{φ s} , \qquad ( 17 )$$

where Y(s)=Z(s)⁻¹ is the admittance of the loudspeaker. The time-domain equivalent of this transfer function is the following:

$${h}_{vx} ( t ) = \frac{1}{φ} ( δ ( t ) - {R}_{e} y ( t ) ) * {ℒ}^{- 1} \{ \frac{1}{s} \} , \qquad ( 18 )$$

where δ(t) is the Dirac pulse, and L⁻¹ denotes the inverse Laplace transform.

Equation (18) shows that the voltage-to-excursion transfer function can be computed as the convolution of an integrator with a linear filter derived from the admittance, y(t), of the loudspeaker.

In the discrete-time case, it can be easily derived that:

$${h}_{vx} [ k ] = \frac{1}{φ} ( δ [ k ] - {R}_{e} y [ k ] ) * {h}_{int} [ k ] , \qquad ( 19 )$$

where δ[k] is the delta function, and hᵢₙₜ[k] is a (leaky) integrator, e.g. described by:

$${h}_{int} ( z ) = \frac{1 / {f}_{s}}{1 - {γ}_{leak} {z}^{- 1}} , \qquad ( 20 )$$

with γₗₑₐₖ the integrator leakage factor and f_{S} is the sampling rate.

The diaphragm displacement can now be obtained by filtering the voltage signal with hᵥₓ[k]. This filtering operation can be split into two filtering operations, one with:

$$\frac{1}{φ} ( δ [ k ] - {R}_{e} y [ k ] )$$

and one with hᵢₙₜ[k].

In the voltage-to-excursion transfer function (Eq. (19)), it is assumed that φ and Re are known. The admittance, y[k] can be estimated as the linear transfer function between the voltage and the current signal, since:

y[k]*v[k]=i[k]. (21)

This relationship can be estimated in the time-domain, using the well-known adaptive filtering theory, e.g. a normalised least-mean-square approach (see, e.g., Haykin, 2002—Adaptive Filter Theory, 4th Edition. Prentice Hall, Upper Saddle River, N.J.).

A schematic rendition of the adaptive scheme is shown in FIG. 2, although the voltage and current measurements can be taken using the circuit of FIG. 1.

The dashed rectangle 30 is the part of the system that estimates the admittance function y[k]. It adapts the coefficients of a filter 32 such that the discrepancy, e[k], between the output of the filter and the current, i[k], is minimal, e.g. in the least-squares sense.

The coefficients of the adaptive filter are optionally smoothed over time, and copied (dashed arrow 34 in FIG. 2) to the part of the system that is used for computing the diaphragm displacement. The filter transfer function comprises the ratio of i[k] to v[k] and thus is a model of the admittance function y[k]. This function y[k] is duplicated in the lower part of the circuit.

The lower part is a possible implementation of Eq. (19), and yields the diaphragm displacement, x[k].

It comprises the copied admittance function 36, a multiplier 38 for multiplying by the blocked resistance Re, and an adder 40 for adding to the impulse function generated by unit 42.

In this way, the admittance function y[k] is multiplied by the blocked electrical impedance Re and subtracted from the delta function δ[k]. The result is scaled by the inverse of the force factor φ by the multiplier 44 before processing by the integrator transfer function hᵢₙₜ[k] in block 46.

v[k], i[k] and e[k] are digitized time signals (for example 16-bit discrete values between −1 and 1). The blocks shown as δ[k] and y[k] can be implemented as impulse responses (FIR filters) of length N.

The block shown as hint[k] is an IIR filter, the transfer function of which is described by Eq. (20), and is characterised by a set of coefficients.

The corresponding acoustical output transfer function can be obtained as the second derivative of hᵥₓ[k], scaled by a constant factor. In the Laplace domain, this yields:

$${h}_{vp} ( s ) = \frac{{ρ}_{0} {S}_{d}}{2 π d} {s}^{2} {h}_{vx} ( s ) , \qquad ( 22 )$$

Where ρ₀ is the density of air, S_{d} is the effective diaphragm radiating area, and d is the distance between loudspeaker and evaluation point. This transfer function assumes a half-plane radiation and neglects the phase lag caused by wave propagation (thus, the phase information is incorrect).

From Eq. (19), the time-domain voltage-to-acoustical output transfer function can be obtained:

$${h}_{vp} [ k ] = \frac{{ρ}_{0} {S}_{d}}{2 π d φ} ( δ [ k ] - {R}_{e} y [ k ] ) * {h}_{diff} [ k ] , \qquad ( 23 )$$

where h_{diff}[k] is a time-domain differentiator described by:

$${h}_{diff} [ z ] = 2 {f}_{s} \frac{1 - {z}^{- 1}}{1 + {z}^{- 1}} \qquad ( 24 )$$

The transfer function (Eq. (23)) can be used for non-parametric linearisation of the acoustic response of the loudspeaker, i.e. to derive a filtering operation that renders the expected acoustical response uniform across frequencies, or to derive a filtering operation that changes the expected acoustical response to a certain desired response.

There is thus a method to predict the diaphragm displacement for a given input voltage. The transfer function(s) are computed on the basis of recordings of voltage across and current flowing into the loudspeaker voice coil, or are computed in an on-line fashion while sound is played on the loudspeaker. The transfer function(s) are computed in the time domain and the method avoids the need for a parametric model of a loudspeaker.

The approach above can be implemented by the circuit of FIG. 1. A series resistor can be used for current sensing, in the path of the voice coil of the loudspeaker. The voltages on each end of the resistor are then monitored by the processor 22, which implements the algorithm.

Reference is also made above to EP11173638, as disclosing a way of obtaining a measure of loudspeaker distortion.

The measure of non-linearity is also based on the voice coil voltage and current.

One known non-linearity measure is the maximum excursion. However, a more generic measurement of non-linearity can be made. The non-linearity parameter can then be used as the control input for the processing of the audio signal. A feedback control loop can then be formed which avoids the need for the input-voltage-to-excursion transfer function.

There are several possibilities to compute the measure of non-linearity based on the electrical impedance of the loudspeaker:

v[k]=i[k]*z[k] (25)

where * denotes the convolution operator, and z[k] is the impulse response corresponding to the electrical impedance function of the loudspeaker (the linear transfer function from current to voltage).

A first possibility uses a fixed electrical impedance, that is determined in an initial estimation phase.

The impedance function can be determined by playing a noise sequence on the loudspeaker at a low amplitude, such that the diaphragm displacement is very small, and computing the transfer function from current to voltage. Estimation methods are available in the literature.

The impulse response corresponding to this transfer function is referred to as z₀[k]. The measure of non-linearity is derived from the discrepancy between the measured voltage \tilde{v}[k], and that expected from the measured current ĩ[k], given the fixed electrical impedance:

e₀[k]=\tilde{v}[k]−ĩ[k]*z₀[k] (26)

An example non-linearity measure is the ratio of the (smoothed) signal powers of the measured voltage and e₀[k].

A second possibility uses an adaptive electrical impedance, that is estimated in an on-line manner. Indeed, the impedance can be estimated using an adaptive filter that minimises the following error signal in terms of the impulse response z₁[k]:

e₁[k]=\tilde{v}[k]−ĩ[k]*z₁[k] (27)

This possibility adapts to changes in the impedance function due to, e.g., loudspeaker aging, and takes into account differences across samples. Furthermore, it does not require an initial estimation stage.

The circuit of FIG. 1 can again implement the non-linearity analysis explained above, with the processor 22 implementing the algorithm to derive the non-linearity or distortion measure.

The invention derives loudspeaker characteristics and/or diagnostics which can be used to control the audio processing in order to implement loudspeaker protection and/or acoustic signal processing (such as flattening, or frequency selective filtering). Mechanical and thermal protection is particularly interesting for customers that want to maintain control over the audio path, without having to develop methods to obtain the loudspeaker diagnostics. The invention can also be used in a loudspeaker maximisation algorithm. It can also be used to linearise the acoustic response of a loudspeaker, to make it uniform across frequencies (to give a flat frequency response) or to make it as close as possible to a desired frequency response, in a non-parametric manner, i.e., without assuming knowledge regarding the enclosure. The invention is also able to handle complex designs of the enclosure without requiring a more complex model.

EP10152597 (published as EP 2 355 542) is mentioned above. This discloses a frequency domain analysis which is analogous to the time domain analysis outlined above, and which is disclosed in unpublished EP11170997.

The characteristics and/or diagnostics generated by the amplifier can be used by any independent processor. This independent processor will then process the digital audio input signal to implement the desired processing before it is supplied to the amplifier circuit of the invention.

The means for determining a clipping level can comprise a measure derived from the measured battery voltage (when the battery voltage drops, the amplifier clipping level drops also), or a measure derived from the observed distortion in the current sense signal, since the clipping behaviour will also be apparent in the measured current signal.

The invention does not reside in the specific characteristics and diagnostics that are measured, and indeed any other known loudspeaker parameters than can be obtained from the current and voltage signals and amplifier characteristics can be provided as output. The invention involves separation of the diagnostic measurements and the audio signal processing, so that a device is provided which essentially provides only the basic signal amplification and diagnostic functions—the diagnostic information is then used by other circuitry.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A loudspeaker drive circuit for deriving at least one of characteristics and diagnostics of a loudspeaker driven by the drive circuit, comprising:
an amplifier;
an element for determining a clipping level of the amplifier;
an element for sensing the current flowing into the loudspeaker;
a processing module to determine the loudspeaker characteristics and/or diagnostics, based on an input audio, the sensed current and the clipping level of the amplifier; and
an element for outputting the characteristics and/or diagnostics.

2. A circuit as claimed in claim 1, wherein the processing module is adapted to derive a loudspeaker temperature.

3. A circuit as claimed in claim 1, wherein the processing module is adapted to derive the amplifier output voltage which is supplied to the loudspeaker based on the audio input provided to the circuit and the known gain and clipping level of the amplifier.

4. A circuit as claimed in claim 3, wherein the drive circuit comprises a delay element between the audio input and the amplifier, such that the derived amplifier output voltage is a predicted amplifier output voltage to be supplied to the loudspeaker after a delay of the delay element.

5. A circuit as claimed in claim 3, wherein the processing module is adapted to derive an electrical impedance function from the amplifier output voltage and the sensed current.

6. A circuit as claimed in claim 5, wherein the processing module is adapted to derive a voltage to displacement transfer function for the loudspeaker, and thereby derive the loudspeaker excursion based on the amplifier output voltage.

7. A circuit as claimed in claim 5, wherein the processing module is adapted to derive a measure of loudspeaker distortion based on the electrical impedance function.

8. A circuit as claimed in claim 5, wherein the processing module is adapted to derive a resonance frequency and/or a Q-factor for the loudspeaker from the electrical impedance function.

9. A method of deriving at least one of characteristics and diagnostics of a loudspeaker, comprising:
driving the loudspeaker using an amplifier;
determining a clipping level of the amplifier;
sensing a current flowing into the loudspeaker;
determining the loudspeaker characteristics and/or diagnostics, based on an input audio signal, the sensed current and the clipping level of the amplifier; and
outputting the loudspeaker characteristics and/or diagnostics.

10. A method as claimed in claim 9, further comprising deriving the amplifier output voltage which is supplied to the loudspeaker based on the audio input provided to the circuit and the known gain and clipping level of the amplifier.

11. A method as claimed in claim 10, further comprising providing a delay between the audio input and the amplifier, such that the derived amplifier output voltage is a predicted amplifier output voltage to be supplied to the loudspeaker after a delay of the delay element.

12. A method as claimed in claim 10, further comprising deriving a loudspeaker temperature.

13. A method as claimed in claim 10, further comprising deriving an electrical impedance function from the amplifier output voltage and the sensed current.

14. A method as claimed in claim 13, further comprising deriving a voltage to displacement transfer function for the loudspeaker, and thereby deriving the loudspeaker excursion based on the amplifier output voltage.

15. A method as claimed in claim 13, further comprising, based on the electrical impedance function, deriving at least one of:
a measure of loudspeaker distortion;
a resonance frequency for the loudspeaker; and
a Q-factor for the loudspeaker.
